(19) United States
(12) Patent Application Publication
(10) Pub. No.: US 2011/0163977 A1
(43) Pub. Date: Jul. 7, 2011

(54) Mode Dependent Configuration of Portable Electronic Device

(76) Inventors: Ulrich Barnhoefer, Sunnyvale, CA (US); Brett Gregory Alten, Cupertino, CA (US)

(21) Appl. No.: 12/842,918

(22) Filed: Jul. 23, 2010

Related U.S. Application Data
(60) Provisional application No. 61/292,777, filed on Jan. 6, 2010.

(51) Int. Cl. G06F 3/041

(52) U.S. Cl. 345/173

(57) ABSTRACT

Improved ways to operate a portable electronic device in a mode-dependent manner are disclosed. In one embodiment, the portable electronic device is a multi-function portable electronic device that can be configured differently based on a particular mode being used. Advantageously, with mode-based configurations, the portable electronic device can operate efficiently and effectively in various different modes. The mode-based configurations can save power, increase efficiency, and/or speed up operation of the device.

### CROSS-REFERENCE TO OTHER APPLICATION

This claims priority to U.S. Provisional Patent Application No. 61/292,777, filed Jan. 6, 2010, entitled “MODE DEPENDENT CONFIGURATION OF PORTABLE ELECTRONIC DEVICE”, which is hereby incorporated herein by reference.

### BACKGROUND OF THE INVENTION

Portable computers, such as notebook computers, are multi-purpose devices that are controlled by software and users to perform desired functions. Given the breath of functions and capabilities to be supported by portable computers, they are not usually optimized for performing any one function. On the other hand, dedicated, limited purpose devices can be optimized for performance of a particular limited purpose. One example of a limited purpose device is an e-reader (or e-book reader). The e-reader can be relatively power efficient through use of e-ink display technology. Hence, traditionally, there is a tradeoff between multi-functionality and low power consumption.

### SUMMARY

Improved ways to operate a portable electronic device in a mode-dependent manner are disclosed. In one embodiment, the portable electronic device is a multi-function portable electronic device that can be configured differently based on a particular mode being used. Advantageously, with mode-based configurations, the portable electronic device can operate efficiently and effectively in various different modes. The mode-based configurations can save power, increase efficiency, and/or speed up operation of the device.

Embodiments of the invention can be implemented in numerous ways, including as a method, system, device, apparatus (including computer readable medium and graphical user interface). Several embodiments of the invention are discussed below.

According to one embodiment, a method for configuring a portable electronic device can, for example, include determining whether the portable electronic device is in an e-reader mode, and configuring the portable electronic device to operate in accordance with a e-reader system profile if the determining determines that the portable electronic device is in the e-reader mode.

According to one embodiment, a portable electronic device can, for example, include a processing unit configured to perform computer program code, a display, a display controller configured to control the display, and a configuration manager operatively connected to the processing unit and/or the display controller. The configuration manager can be configured to monitor whether the portable electronic device is in an e-reader mode, and to operate the portable electronic device in accordance with an e-reader system profile while the portable electronic device is in the e-reader mode.

According to one embodiment, a method for operating a portable electronic device to present an e-book on a display device associated with the portable electronic device can determine whether an e-book is to be presented on the display device. When it is determined that the e-book is to be presented on the display device, an e-book presentation profile corresponding to the e-book can be accessed. The portable electronic device can be configured in accordance with the e-book presentation profile. The e-book can then be presented on the display device of the configured portable electronic device.

According to one embodiment, a computer readable medium includes at least computer program code stored thereon for configuring a portable electronic device to present an e-book on a display device associated with the portable electronic device. More particularly, the computer readable medium includes at least computer program code for accessing an e-book presentation profile corresponding to the e-book, computer program code for configuring the portable electronic device in accordance with the e-book presentation profile, and computer program code for presenting the e-book on the display device of the configured portable electronic device.

According to another embodiment, a computer readable medium including at least computer program code stored thereon for operating a portable electronic device to present an e-book on a display device associated with the portable electronic device. The computer readable medium includes at least computer program code for determining whether an e-book is to be presented on the display device. The computer readable medium can further include computer program code for identifying a page of the e-book to be presented, and computer program code for determining a configuration of the portable electronic device for the identified page based on an e-book presentation profile corresponding to the e-book. Still further, the computer readable medium can also include computer program code for configuring the portable electronic device in accordance with the determined configuration, and computer program code for thereafter presenting the e-book on the display device of the configured portable electronic device.

According to one embodiment, a method for operating a portable electronic device to present an e-book on a display device associated with the portable electronic device. The method can operate to determine whether the portable electronic device is in an e-reader mode. In the e-reader mode, the method operates to identify an e-book to be presented, and configure the portable electronic device to operate in the e-reader mode. The portable electronic device can also provide a plurality of virtual frame buffers for storage of e-book content for the e-book in a data storage device of the portable electronic device. Thereafter, the method can present at least a portion of the e-book on the display device of the configured portable electronic device using the e-book content stored in the virtual frame buffers.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of portable electronic device according to one embodiment.

FIG. 2 is a flow diagram of a mode-based configuration process according to one embodiment.

FIG. 3 is a block diagram of a portable electronic device according to one embodiment.

FIG. 4 is a flow diagram of an e-book presentation process according to one embodiment.

FIG. 5 is a flow diagram of an e-book page presentation process according to one embodiment.

FIG. 6 is a block diagram of portable electronic device according to another embodiment.

FIG. 7 illustrates a plurality of pages that might be presented while presenting an e-book by portable electronic device.

FIG. 8 is a flow diagram of an e-book presentation process according to one embodiment of the invention.

### DETAILED DESCRIPTION OF EMBODIMENTS OF THE INVENTION

Improved ways to operate a portable electronic device in a mode-dependent manner are disclosed. In one embodiment, the portable electronic device is a multi-function portable electronic device that can be configured differently based on a particular mode being used. Advantageously, with mode-based configurations, the portable electronic device can operate efficiently and effectively in various different modes. The mode-based configurations can save power, increase efficiency, and/or speed up operation of the device.

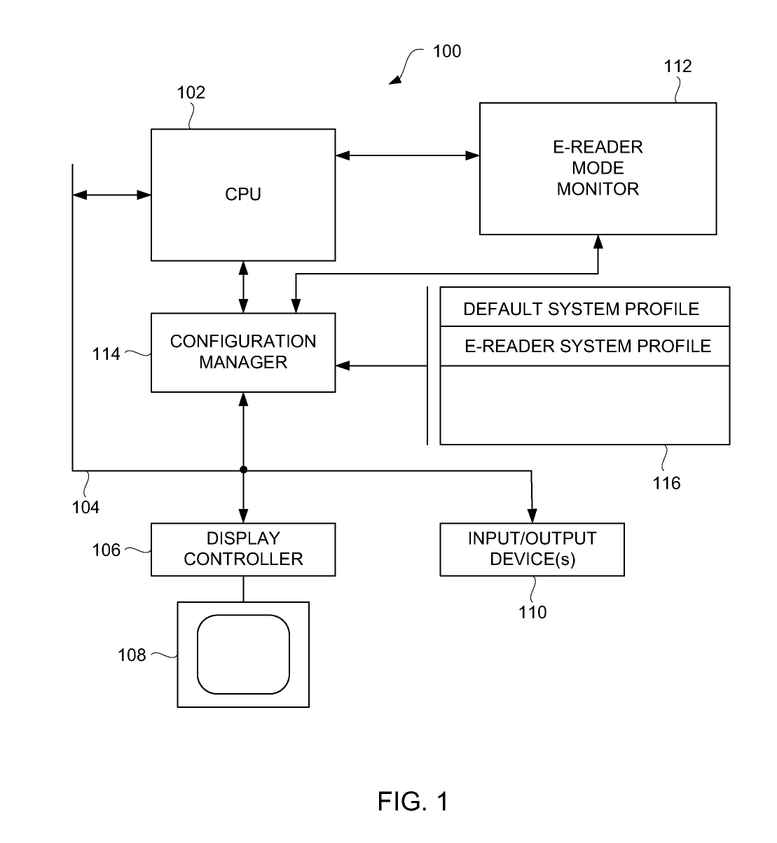

Exemplary embodiments of the invention are discussed below with reference to FIGS. 1-8. However, those skilled in the art will readily appreciate that the detailed description given herein with respect to these figures is for explanatory purposes as the invention extends beyond these limited embodiments.

FIG. 1 is a block diagram of portable electronic device 100 according to one embodiment. Portable electronic device 100 can include central processing unit (CPU) 102. CPU 102 can control overall operation of portable electronic device 100. CPU 102 can be coupled to bus 104. Portable electronic device 100 can also include other electrical components such as, for example, display controller 106, display device 108 and one or more input/output devices 110. Display controller 106 and one or more input/output devices 110 can be coupled to bus 104 and can be controlled by CPU 102. Display controller 106 can provide specialized display related processing so as to produce signals that cause text and graphics to be presented on display device 108. In one embodiment, display controller 106 can be, can include or can couple to a graphical processing unit (GPU). Display device 108 can be a monitor for providing visual output. Additionally, display device 108 can be touch and/or optically sensitive—that is, it can be configured to receive touch and/or optical inputs. One or more input/output devices 110 can also be coupled to bus 104. Examples of input/output devices 110 can vary widely but can, for example, be chosen from at least the group consisting of keyboards, track pads, touch surfaces (e.g., touchscreen, touchpad, etc.), network interfaces, wireless receivers/transmitters, data storage components, etc.

Portable electronic device 100 can also include e-reader mode monitor 112. E-reader mode monitor 112 can be coupled to CPU 102 and/or configuration manager 114. E-reader mode monitor 112 can interact with CPU 102 and/or other components to monitor when portable electronic device 100 is operating in an e-reader mode. For example, if portable electronic device 100 is presently operating an e-book application program, e-reader mode monitor 112 can discover or be informed that the portable electronic device 100 is operating an e-book application program. When e-reader mode monitor 112 determines that portable electronic device 100 is operating an e-book application program, e-reader mode monitor 112 can directly or indirectly inform configuration manager 114 that portable electronic device 100 is now operating in an e-reader mode.

Configuration manager 114 can operate to configure one more electronic components of portable electronic device 100 in accordance with the operational mode of portable electronic device 100. In the example illustrated in FIG. 1, for example, it is assumed that portable electronic device 100 is operational and has at least two modes. A first mode is referred to as a default (or normal) mode, and a second node is referred to as an e-reader mode. Configuration manager 114 can be implemented as hardware, firmware, or software, depending on the overall architecture and requirements of the device.

Configuration manager 114 can access data store 116 to retrieve an appropriate system profile. After configuration manager 114 has retrieved the appropriate system profile, configuration manager 114 can configure one or more electrical components of portable electronic device 100 in accordance to be appropriate system profile. That is, configuration manager 114 can change one or more operational parameters to optimize or otherwise modify the performance of the device in a particular operational mode. More specifically, if e-reader mode monitor 112 determines that portable electronic device 100 is operating in an e-reader mode, configuration manager 114 can retrieve the e-reader system profile, and then configure the one or more electrical components of portable electronic device 100 in accordance with the e-reader system profile. On the other hand, when configuration manager 114 understands that portable electronic device 100 is not operating in an e-reader mode, configuration manager 114 can retrieve a default system profile, and then configure the one or more electrical components of the portable electronic device 100 in accordance with the default system profile.

In one embodiment, e-reader mode monitor 112 can be implemented by CPU 102 performing processing to determine whether portable electronic device 100 is being used in an e-reader mode. For example, e-reader mode monitor 112 can evaluate whether an e-reader application is active and in use on portable electronic device 100. In one implementation, computer code executed by the CPU 102 can perform e-reader mode monitor 112 and whether an e-reader application is active and in use (e.g., active application program on portable electronic device 100).

Depending on the functionality of portable electronic device 100, configuration manager 114 and data store 116 can support various different other modes of operation and corresponding system profiles. Hence, more generally, e-reader mode monitor 112 can be referred to as an operational mode monitor.

As noted above, configuration manager 114 can configure portable electronic device 100 to operate in accordance with an e-reader system profile. Additionally or alternatively, configuration manager 114 can configure portable electronic device 100 to operate in accordance with one or more profiles when operating in an e-reader mode. These one or more profiles serve to configure portable electronic device 100 for desired operation, often efficient operation and possibly preferential operation. In this regard, one or more different profiles can be made available to configuration manager 114. As a result, the mode of operation of portable electronic device 100 can be influenced or dependent on one or more profiles. The profiles can be system profiles, user profiles, content profiles and/or presentation profiles. System profiles were noted above and provide the general profile for a particular mode of operation. For example, in an e-reader mode, certain electrical components can be disable or placed in a low power state. User profiles are profiles that are provide for users. In one embodiment, user preferences can be provided in a user profile. A user profile can also be established as a customization to a system profile. A content profile is a profile that is associated with a content type (e.g., text only, text and graphics, etc.). A presentation profile provides a profile from a provider of content. The profiles can be used separately or in any combination. A profile as used herein can refer to any one or more of system profile, user profile, content profile and/or presentation profile. In one embodiment, a system profile can subsume a user profile and/or content profile.

Profile selection can be performed by configuration manager 112 based on programmatic instructions. However, user input can be used to influence profile selection. For example, a user may sometime desire to sacrifice some power for an enhanced user experience. As another example, different users might prefer different profiles. Portable electronic device 100 (e.g., electrical components therein, such as a GPS receiver, accelerometer, light sensor, user activity, etc.) can also be used to influence profile selection. For example, a system profile can build in variations based on data from one or more of these components of portable electronic device 100. As one example, different environments (e.g., ambient light levels) could influence system profile or profile selection. An another example, different geographic locations could influence system profile or profile selection. As still another example, different user activity could influence system profile or profile selection.

Additional information concerning mode monitoring, mode-based configuration, user input monitoring and processing can be found in: (i) U.S. Provisional Patent Application No. 61/292,772, filed Jan. 6, 2010, and entitled “PORTABLE ELECTRONIC DEVICE HAVING MODE DEPENDENT USER INPUT CONTROLS,” which is hereby incorporated herein by reference in its entirety; and (ii) U.S. Provisional Patent Application No. ______ [Att. Dkt. No.: 101-P716/P8816US1], filed currently herewith, and entitled “PORTABLE ELECTRONIC DEVICE HAVING MODE DEPENDENT USER INPUT CONTROLS,” which is hereby incorporated herein by reference in its entirety.

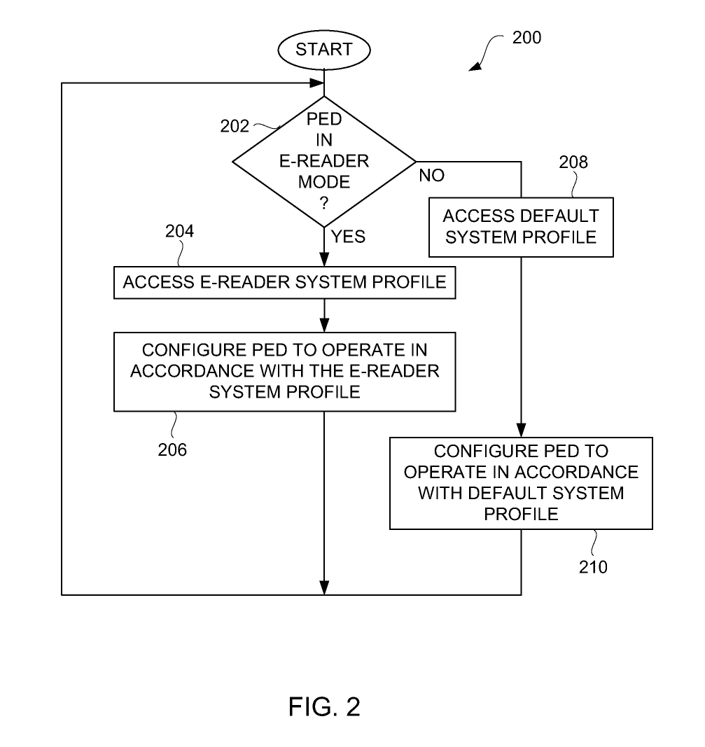

FIG. 2 is a flow diagram of mode-based configuration process 200 according to one embodiment. Mode-based configuration process 200 can, for example, be performed by a portable electronic device, such as portable electronic device 100 illustrated in FIG. 1. In this embodiment, the portable electronic device is a multi-function portable electronic device that operates in a plurality of different modes, including at least an e-reader mode and a default mode.

Mode-based configuration process 200 can begin with decision 202 that determines whether the portable electronic device is in an e-reader mode. When decision 202 determines that the portable electronic device is in an e-reader mode, an e-reader system profile can be accessed 204. The e-reader system profile is a system profile that describes how the portable electronic is to be configured for optimized usage in the e-reader mode. For example, the e-reader system profile can specify that certain hardware components can be disabled or slowed and/or can specify parameters to be used (e.g., refresh rate, contrast ratio, etc.). The e-reader system profile can be predetermined, system determined and/or can be user determined. After the e-reader system profile has been accessed, the portable electronic device can be configured 206 to operate in accordance with the e-reader system profile. Advantageously, the portable electronic device can be efficiently operated in the different modes. As one example, the efficient operation can, for example, conserve battery charge (or battery power) by disabling or slowing certain hardware components. As another example, the efficient operation can enhance display device characteristics for the mode of operation.

On the other hand, when decision 202 determines that the portable electronic device is not in an e-reader mode, a default system profile can be accessed 208. The default system profile can be a normal configuration profile that is used when a special purpose system profile (e.g., e-reader system profile) is not being utilized. Thereafter, the portable electronic device can be configured 210 to operate in accordance with the default system profile.

Following block 206 as well as following block 210, mode-based configuration process 200 can return to repeat decision 202 so that continuous mode monitoring can be performed. Accordingly, the configuration of the portable electronic device can be dynamically changed as the mode of usage of the portable electronic device changes. Consequently, the portable electronic is able to be configured dependent on its mode of use. However, in alternative embodiments, the mode monitoring can be performed periodically or on demand (e.g., as specifically requested).

As noted above, a system profile used to configure hardware components can specify that certain hardware components can be disabled or slowed and/or can specify parameters to be used (e.g., refresh rate, contrast ratio, color/black-white, etc.). For instance, in an e-reader mode, a display device can be controlled in accordance with specified parameters such that its operation consumes less power, e.g., by one or more of: reducing refresh rate, reducing contrast, operate in black & white (or minimum color) instead of color (or full color), lower display intensity, lower backlight level (if any), reducing size of active area of display screen, etc. One exemplary representation of a data store storing an e-reader system profile and a default system profile is provided in Table I below.

TABLE I

| Component | e-reader sys. profile | Default sys. profile |
|---|---|---|
| Refresh Rate | Low | Normal |
| Color | No | Yes |
| GPU | Min. | On |
| Wireless Interface | Off | On |
| Touch Surface | Off | On |
| GPS | Off | On |

Table I is merely exemplary. As additional examples, a system profile could specify (i) whether all or only a specific portion of a touchscreen is to be enabled, (ii) touch surface sensitivity, (iii) touch surface scanning rate, and (iv) the like. As another example, a system profile can also include idle detection parameters that can be used to determine whether the user is not actively using the portable electronic device. For example, the portable electronic device can determine a user is not active using sensors (proximity sensors, image sensing, last input timer, etc.). Also, system profiles can specify that certain hardware components can be disabled or slowed and/or can specify parameters to be used (e.g., refresh rate, contrast ratio, color/black-white, etc.). As another example, a system profile can also include an indication of whether (and/or the extent of which) advertising is permitted or enabled.

In one embodiment, a system profile can also be influenced by a user of a portable electronic device. For example, a user can provide preference settings for device requirements in certain one or more modes of operation. A graphical user interface screen can be made available on the portable electronic device to permit user preference settings. As another example, a graphical user interface screen can be presented to a user with options (i.e., selectable by the user) that influence how a portable electronic device is to be configured. User preferences can also be provided as a user profile. For example, a user might establish a user profile for use (e.g., separate from or together with a system profile) to configure a portable electronic device.

A system profile can also include or be used in conjunction with a content profile and/or a presentation profile. A content profile can be a profile for particular content. For example, content can refer to content being present to a user while the portable electronic device is an e-reader mode. The content profile can specify that the portable electronic device is to be configured differently depending on the content presented or to be presented. For example, if the content is text only, the GPU can be placed in a sleep mode or deactivated.

The profiles can be system profiles, user profiles, content profiles and presentation profiles. Any of these profiles can be used separately or in combination. In one embodiment, in mode-based configuration process 200, access 204 to the e-reader system profile can involve determining an appropriate one or more profiles to be used.

Still further, a system profile can also be at least partially determined by the portable electronic device or by a system, such as a remote server. The portable electronic device or the system can monitor user behavior in one or more of the available modes of operation, and then through analysis of such data, one or more system profiles can be modified in view of the user behavior. For example, with the minimum setting for the GPU in the e-reader system profile can correspond to a periodic activation of the GPU, and user behavior can be use to set the period for the periodic activation. As an example, for an e-reader mode, slower readers can have a longer duration of time between the periodic activation of the GPU.

Also, if there are various profiles available, the portable electronic device can dynamically determine an appropriate one or more profiles to be used. Alternatively, a user can be presented with a menu or list of available profiles via a graphical user interface. The menu or list might also produce a duration indication (e.g., operational time in view of mode of use and available battery energy). The user can then select one of the menu or list items, thereby designating a profile to be used in configuring the portable electronic device.

In still another embodiment, a particular hardware component could be enabled to provide operation in a particular mode in which complex processing, such as from a graphics processing unit (GPU), is substantially reduced. For example, in an e-reader mode, a specialized integrated circuit (e.g., ASIC) could be utilized to provide processing and perhaps control for a display device. The specialized integrated circuit would provide low power operation in the e-reader mode as compared to a normal operational mode, which might utilize a GPU. For example, the specialized integrated processor can be an e-book controller.

In yet another embodiment, the portable electronic device includes a system memory (e.g., RAM, ROM, storage drive, etc.). The system memory can be accessed by a CPU. Alternatively, the system memory can be accessed by through Direct Memory Access (DMA), in which hardware components can directly access without needing assistance of the CPU (beyond initiating the data transfer) to transfer data to or from the system memory. Hence, when configuring the portable electronic device for operation in different modes, DMA can be utilized to reduce power consumption. For example, an e-reader mode could operate to allow hardware components of a portable electronic device to directly access the system memory to retrieve data corresponding to an e-book. In one implementation, a specialized integrated circuit can provide data processing and/or display control to present pages on a display device. The specialized device can access the system memory to retrieve data corresponding to the e-book using DMA, which allows the CPU to remain in a low power state.

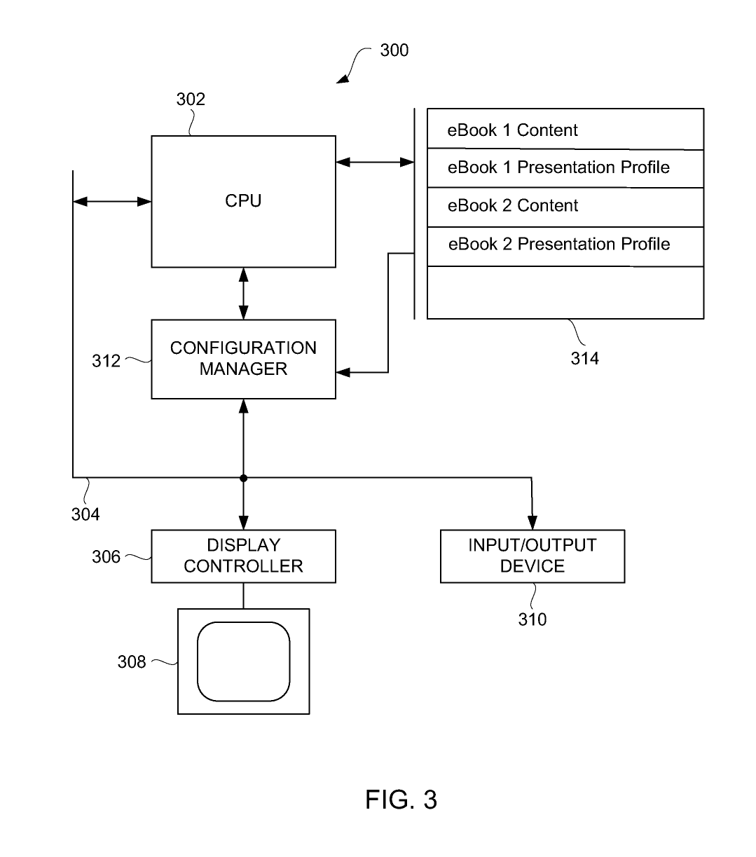

FIG. 3 is a block diagram of portable electronic device 300 according to one embodiment. The portable electronic device 300 includes central processing unit (CPU) 302. CPU 302 can control overall operation of portable electronic device 300. CPU 302 can be coupled to bus 304. Portable electronic device 300 can also include other electrical components such as, for example, display controller 306, display device 308 and one or more input/output devices 310. Display controller 306 and one or more input/output devices 310 can be coupled to bus 304 and can be controlled by CPU 302. Display controller 306 can provide specialized display related processing so as to produce signals that cause text and graphics to be presented on display device 308. In one embodiment, display controller 306 can be, can include or can couple to a graphical processing unit (GPU). Display device 308 can be a monitor for providing visual output. Alternatively, display device 308 can be a touchscreen that can provide not only visual outputs but also touch inputs. One or more input/output devices 310 can also be coupled to bus 304. Examples of input/output devices 310 can vary widely but can, for example, be chosen from at least the group consisting of keyboards, track pads, touch surfaces (e.g., touchscreen, touchpad, etc.), network interfaces, wireless receivers/transmitters, data storage components, etc.

Portable electronic device 300 can also include configuration manager 312. Configuration manager 312 can coupled to CPU 302 and/or bus 304. Configuration manager 312 can operate to configure one more electronic components of portable electronic device 300 in accordance with an operation of portable electronic device 100. In the example illustrated in FIG. 3, it is assumed that portable electronic device 300 is operational to provide e-reader functionality. Portable electronic device 300 can be a dedicated e-reader product or can be a multi-function portable electronic device that has an e-reader capability.

Portable electronic device 300 can also include data store 314. Data store 314 can store at least e-book data for one or more e-books. In one embodiment, data store 314 can store content and a presentation profile for one or more e-books. In the example illustrated in FIG. 3, data store 314 includes e-book data for two e-books, “eBbook 1” and “eBook 2”. Configuration manager 312 can access data store 314 to retrieve an appropriate presentation profile. For example, if the e-book “eBook 2” is to be presented by portable electronic device 300, configuration manager 312 can retrieve the presentation profile denoted “eBook 2 Presentation Profile”. After configuration manager 112 has retrieved the appropriate presentation profile, configuration manager 112 can configure one or more electrical components of portable electronic device 300 in accordance with the appropriate presentation profile. As such, portable electronic device 300 can be configured in accordance with a presentation profile that is associated with an e-book. In one embodiment, a presentation profile is provided for a given e-book so as to specify its system requirements and preferences. Based on the presentation profile (with possible consideration of user preferences or behavior), configuration manager 312 is able to configure the one or more electrical components of portable electronic device 300 to operate efficiently when presenting the e-book, yet also enable the e-book to be presented in an intended manner by the author, publisher, or distributor. For example, the presentation profile can control or influence any of a number of different aspects associated with presentation of an e-book. For example, the aspects can include display characteristics (e.g., contrast, brightness, refresh rate, color/black-white) and/or hardware usage (e.g., wireless, GPS, touch surfaces, GPU).

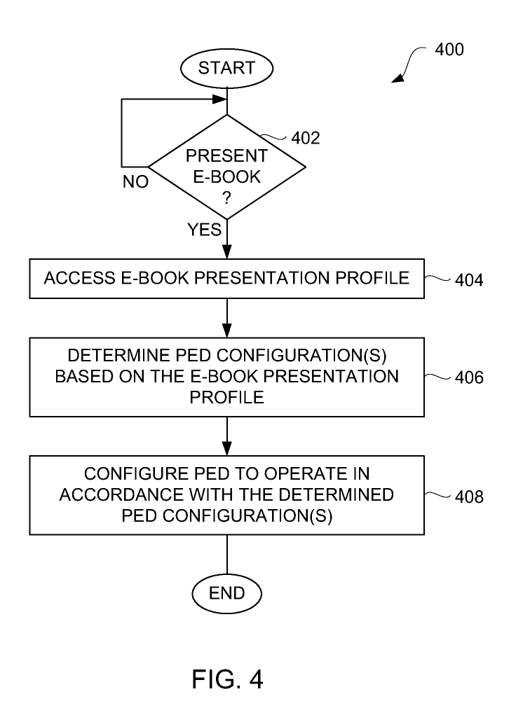

FIG. 4 is a flow diagram of e-book presentation process 400 according to one embodiment. E-book presentation process 400 can be performed by a portable electronic device, such as portable electronic device 300 illustrated in FIG. 3.

E-book presentation process 400 can begin with decision 402 that determines whether an e-book is to be presented. When decision 402 determines that an e-book is not to be presented, E-book presentation process 400 can await the need to present an e-book. On the other hand, once decision 402 determines that an e-book is to be presented, E-book presentation process 400 can continue. More specifically, when decision 402 determines that an e-book is to be presented, an e-book presentation profile can be accessed 404. In one embodiment, an e-book has electronic data that can be classified as e-book content and e-book presentation profile. Such electronic data for the e-book can be provided in a single electronic file or in multiple electronic files. However, typically, the e-book presentation profile is provided at the same time as the e-book content. For example, a user that purchases an e-book may receive not only e-book content but also an e-book presentation profile for that particular e-book. The e-book presentation profile can specify recommendations for device operation when operating in an e-reader mode to present the particular e-book.

After the e-book presentation profile has been accessed 404, the e-book presentation process 400 can determine 406 one or more portable electronic device configurations based on the e-book presentation profile. Here, when presenting the e-book at the portable electronic device, the e-book presentation profile can cause the portable electronic device to be configured appropriately when presenting the e-book. The e-book presentation profile can include recommendations pertaining to display characteristics (e.g., contrast, brightness, refresh rate, color/black-white), hardware usage (e.g., wireless, GPS, touch surfaces, GPU), etc. The portable electronic device can then operate to follow some or all of the recommendations provided in the e-book presentation profile. User preferences, user selections, location or system resources can impact or alter the e-book presentation profile.

After the one or more portable electronic device configurations have been determined 406, the portable electronic device can be configured 408 to operate in accordance with the one or more determined portable electronic device configurations. Following block 408, the e-book presentation process 400 can end. At the end of the e-book presentation, the portable electronic device can operate (e.g., be reconfigured) in some other mode (e.g., default mode), and the portable electronic device can then be optimized to operate in accordance with the then existing mode of operation.

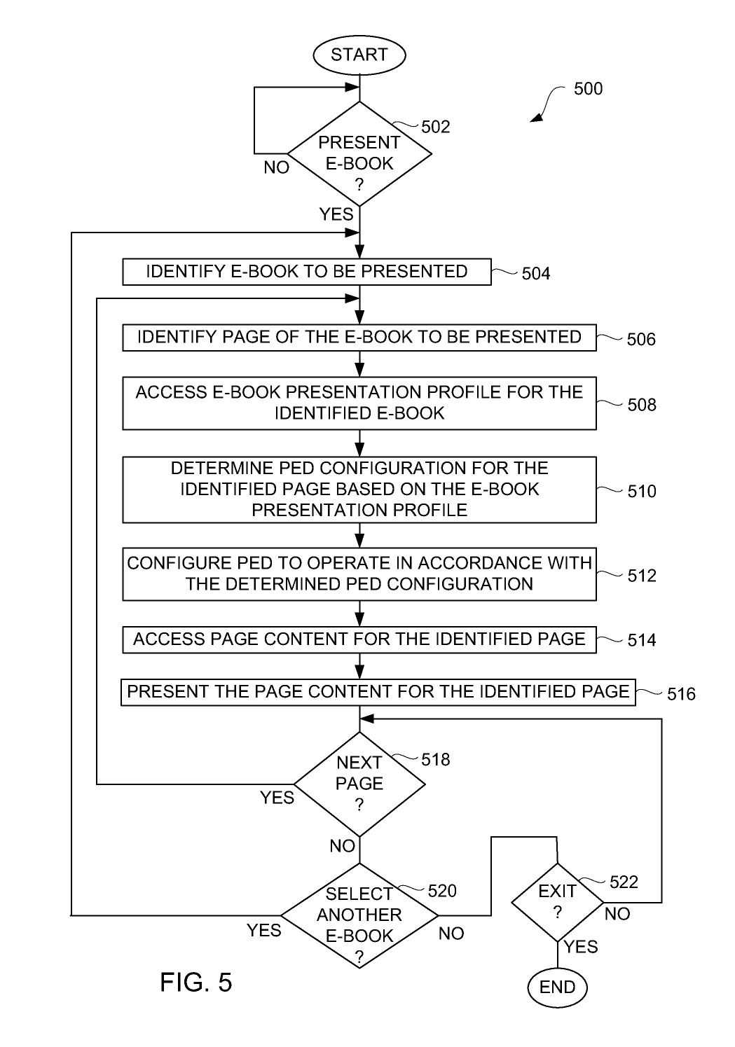

FIG. 5 is a flow diagram of e-book page presentation process 500 according to one embodiment. E-book page presentation process 500 can, for example, be performed by a portable electronic device, such as portable electronic device 300 illustrated in FIG. 3.

E-book page presentation process 500 can begin with decision 502 that determines whether an e-book is to be presented. When decision 502 determines that an e-book is not to be presented at this time, e-book page presentation process 500 can await the need to present an e-book. Once decision 502 determines that an e-book is to be presented, the e-book to be presented can be identified 504. An e-book is a multi-page electronic document that can be presented in a manner that resembles a book.

After the e-book to be presented has been identified 504, a page of the e-book to be presented can be identified 506. An e-book presentation profile associated with the e-book to be presented can also be accessed 508. Next, a portable electronic device configuration for the identified page can be determined 510 based at least in part on the e-book presentation profile. Here, the e-book presentation profile can provide portable electronic device configuration information on a per page basis. Hence, different pages can, but need not, result in a different configuration for the portable electronic device. The portable electronic device can then be configured 512 to operate in accordance with the determined portable electronic device configuration.

In addition, page content for the identified page can be accessed 514. The page content for the identified page can then be presented 516. For example, the page content for the identified page can be presented on a display device, such as the display device 308 illustrated in FIG. 3.

Next, decision 518 can determine whether a next page in the e-book is to be presented. When decision 518 determines that a next page is to be presented, e-book page presentation process 500 returns to repeat block 506 and subsequent blocks so that the next page can be identified and similarly processed. Alternatively, when decision 518 determines that a next page is not requested to be presented, decision 520 can determine whether another e-book is to be selected for presentation. When decision 520 determines that another e-book is to be selected for presentation, e-book page presentation process 500 can return to repeat block 504 and subsequent blocks so that another e-book can be identified and similarly processed.

Alternatively, when decision 520 determines that another e-book is to be selected for presentation, decision 522 can determine whether e-book page presentation process 500 should end. When decision 522 determines that e-book page presentation process 500 should not exit, e-book page presentation process 500 can return to repeat decision 518 and subsequent blocks. On the other hand, when decision 522 determines that e-book page presentation process 500 should exit, then e-book page presentation process 500 can end.

According to another embodiment, virtual frame buffers can be used to present an e-book on a portable electronic device. The use of virtual frame buffers serves to facilitate e-book presentation on a portable electronic device with reduced processing burdens and/or with reduced graphics support.

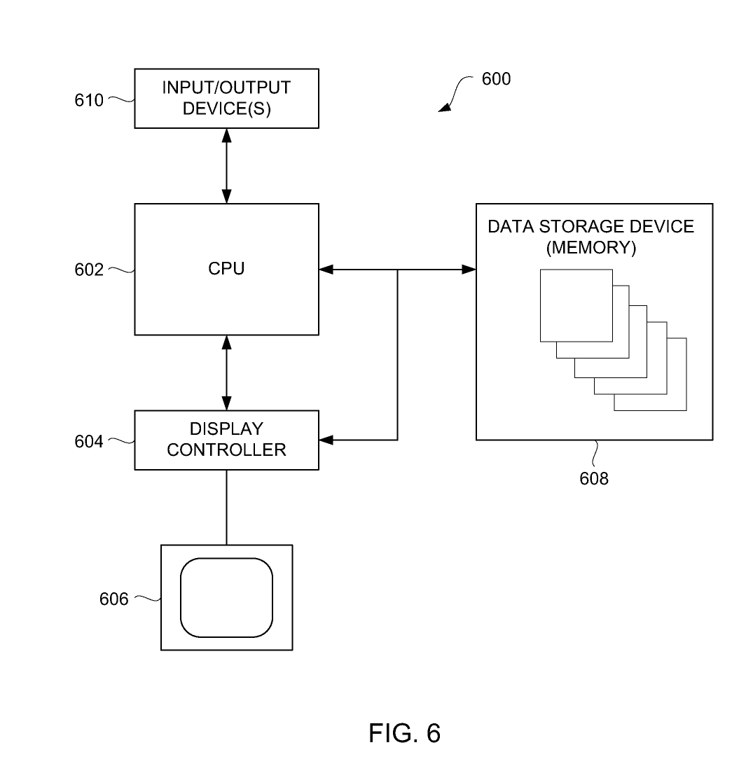

FIG. 6 is a block diagram of portable electronic device 600 according to another embodiment. Portable electronic device 600 includes central processing unit (CPU) 602. CPU 602 can control overall operation of portable electronic device 600. Portable electronic device 600 can also include other electrical components such as, for example, display controller 604 and display device 606. Display controller 604 can be at least partially controlled by CPU 602. Display controller 604 can provide signals to produce a visual display on display device 606. Display controller 604 can provide specialized display related processing so as to produce signals that cause text and graphics to be presented on display device 606. In one embodiment, display controller 606 can be, can include or can couple to a graphical processing unit (GPU) to perform complex processing for graphical visual displays. Display device 608 can be a monitor for providing visual output. Alternatively, display device 608 can be a touchscreen that can provide not only visual outputs but also support touch inputs.

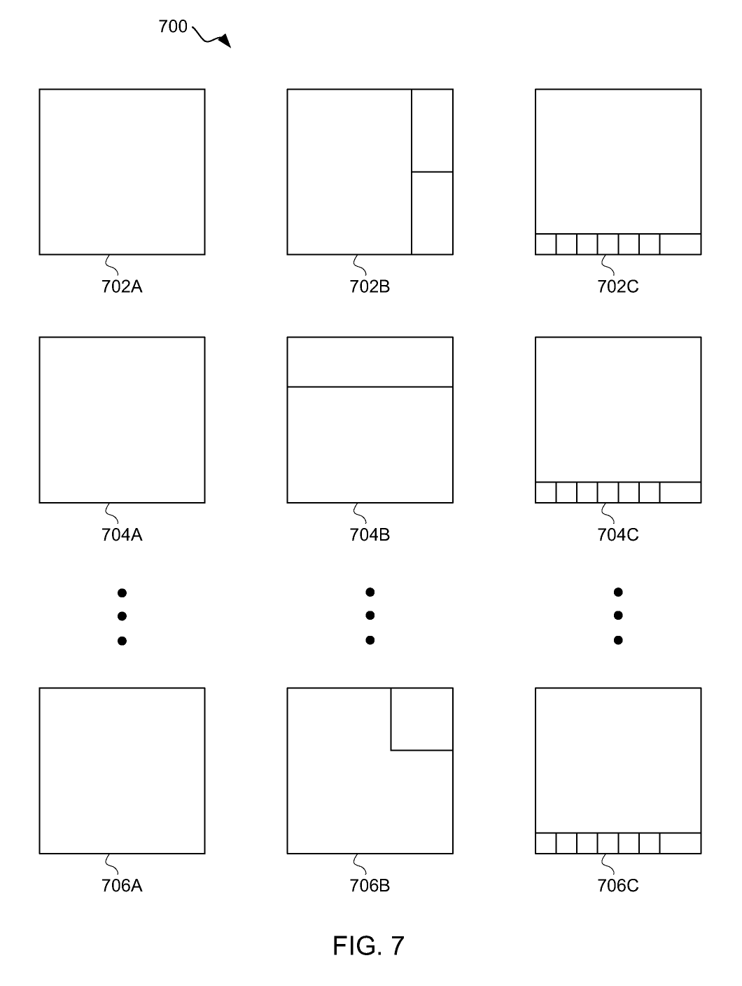

Additionally, portable electronic device 600 includes data storage device 608 (or memory) that provides storage for data utilized by portable electronic device 600. According to one aspect of portable electronic device 600, data storage device 608 can operate to store a plurality of virtual frame buffers. More particularly, data storage device 608 can store a plurality of virtual frame buffers that each correspond to images that can be presented on display device 606 by display controller 604 in accordance with the operation of portable electronic device 600. For example, portable electronic device 600 can operate in an e-reader mode in which an e-book can be presented on display device 606 of portable electronic device 600 in an efficient manner, namely, in a power efficient manner, whereby the processing workload required by CPU 602 and/or display controller 604 can of the substantially reduced. To support such efficient operation, data storage device 608 can operate to store a plurality of virtual frame buffers. Typically, the virtual frame buffers are provided in a semiconductor memory storage device. Hence, at least a portion of the data storage device 608 can be semiconductor memory. The images in the virtual frame buffers can correspond to pages of the e-book that may be required to be presented on display device 606. However, beyond the basic pages to be presented, other variations to the pages that can, in some embodiments, be caused to be displayed on display device 606. Hence, the possible variations to the basic pages can be provided as additional images in the virtual frame buffers. Exemplary variations are discovered below with reference to FIG. 7.

Portable electronic device 600 can also include one or more input/output devices 610. Input/output devices 610 can be coupled to CPU 602. Input/output devices 610 can provide the ability for a user to provide input to portable electronic device 600 as well as for additional potential ways portable electronic device 600 can provide output to the user. Examples of input/output devices 610 can vary widely but can, for example, be chosen from at least the group consisting of: keyboards, track pads, touch surfaces (e.g., touchscreen, touchpad, etc.), network interfaces, wireless receivers/transmitters, data storage components, etc.

FIG. 7 illustrates a plurality of pages that might be presented while presenting an e-book by portable electronic device 600. Images corresponding to these pages can be stored in virtual frame buffers, such as in data storage device 608 illustrated in FIG. 6. Page 702A can represent a basic text page for a first page of the e-book. Page 704A can represent a basic text page for a second page of the e-book. Page 706A can represent a basic text page for an nth page of the e-book. If space is available in the virtual frame buffers, alternative pages or variations of the basic text pages can also be stored in the virtual frame buffers. Page 702B can represent a variation of the first page of the e-book wherein a right side of the presented page has one or more graphical components. The graphical components can pertain to graphics associated with the e-book, or can be graphics associated with marketing or advertising information. Page 704B can represent a variation of the second page of the e-book wherein an upper portion of the presented page has one or more graphical components. Page 706B can represent a variation of the nth page of the e-book wherein an upper corner portion of the presented page has a graphical component. Other variations can be provided with dynamic elements, such as graphical user interface elements that can be presented (e.g., over or superimposed) along with the associated text of the page of the e-book. As an example, the graphical user interface element can be a toolbar that is presented when likely needed by the user of the portable electronic device. Page 702C can represent a variation of the first page of the e-book wherein a bottom side of the presented page includes a toolbar or menu. Page 704C can represent a variation of the second page of the e-book wherein a bottom side of the presented page includes a toolbar or menu. Page 706C can represent a variation of the nth page of the e-book wherein a bottom side of the presented page includes a toolbar or menu. Hence, given the variations, alternations and user interface components, there are various versions of pages that might be presented by an e-book. Therefore, by determining or predicting some or all of these pages in advance and storing the corresponding images in the virtual frame buffers, the need for on-going graphical processing is removed. However, it may be desirable to place in the virtual frame buffers only a limited number of most likely pages. If so, it may be advantageous to manage the set of pages in the virtual frame buffers so that the pages in the virtual frame buffer include those that are most likely to be presented. The management of the pages to be present in the virtual page buffers can include refreshing those pages stored in the virtual frame buffers.

In one embodiment, the images for the pages to be stored in the virtual frame buffers can be generated at the portable electronic device. The images can be generated in advance of a request to present a particular e-book on the portable electronic device. In another embodiment, the images for the pages to be stored in the virtual frame buffers can be generated at another computing device and then transferred to the portable electronic device during a data transfer operation (e.g., via a wired or wireless network).

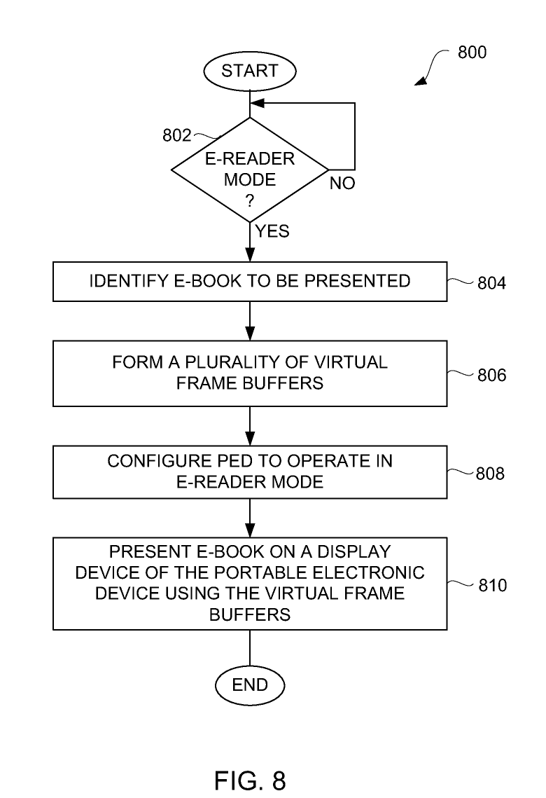

FIG. 8 is a flow diagram of e-book presentation process 800 according to one embodiment of the invention. E-book presentation process 800 can, for example, be performed by a portable electronic device, such as portable electronic device 600 illustrated in FIG. 6.

E-book presentation process 800 can begin with decision 802 that determines whether the portable electronic device is in an e-reader mode. Here, it is assumed that the portable electronic device can operate in any of a number of different modes, e.g., e-reader mode, default mode, media playback mode, etc. When decision 802 determines that the portable electronic device is not in an e-reader mode, E-book presentation process 800 can wait until the portable electronic device is used in the e-reader mode since e-book presentation processing 800 is concerned with e-reader mode processing. Once decision 802 determines that the portable electronic device is in the e-reader mode, the e-book to be presented can be identified 804. In addition, a plurality of virtual frame buffers can be formed 806. The plurality of virtual frame buffers can include at least one virtual frame buffer for each page (of at least a plurality of pages) of the e-book that might be presented. In one implementation, each virtual frame buffer can store data for presentation of a page of the e-book. In addition, the portable electronic device can be configured 808 to operate in the e-reader mode. As discussed above, when operating in the e-reader mode, the portable electronic device can be configured to operate efficiently.

Thereafter, the e-book can be presented 810 on a display device of the portable electronic device using the virtual frame buffers. After an initial page of the e-book has been presented 810, various other pages in the e-book can be subsequently presented through use of the corresponding appropriate one of the virtual frame buffers. As such, the other pages provided in the virtual frame buffers are able to be rapidly displayed with minimal processing burden. Following block 810, the e-book presentation process 800 can end.

By using the virtual frame buffers, the portable electronic device is able to operate in an efficient manner yet properly provide presentation of the e-book and support user requests for interaction with the e-book. For example, complex graphical processing that may be required by a graphical processing unit (GPU) can be reduced or eliminated. In presenting an e-book, most if not all of the images for pages (i.e., screens) required to be presented on the display device can be predetermined or predicted. Hence, the virtual frame buffers can store a plurality of such images. The virtual frame buffers can be implemented by semiconductor memory storage which is fast and power efficient. If the amount of data storage for the virtual frame buffers is inadequate to store all of the images for pages, those images of pages most probable of being required can be stored to the data storage device.

The embodiments described herein are, for example, suitable for use with portable electronic devices. Some examples of portable electronic devices include mobile telephones (e.g., cell phones), Personal Digital Assistants (PDAs), portable media players (e.g., MP3 players), remote controllers, notebook computers, netbook computers, electronic tablets (including tablet computers), e-book readers, portable gaming devices (including game players and game controllers), etc.

The various aspects, features, embodiments or implementations described above can be used alone or in various combinations.

The many features and advantages of embodiments of the invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for configuring a portable electronic device, said method comprising:
determining whether the portable electronic device is in an e-reader mode; and
configuring the portable electronic device to operate in accordance with a e-reader system profile if said determining determines that the portable electronic device is in the e-reader mode.

2. A method as recited in claim 1,
wherein said method comprises:
accessing a user preference or a user profile, and
wherein said configuring of the portable electronic device to operate in accordance with the e-reader configuration is based on the e-reader system profile and the user preference or the user profile.

3. A method as recited in claim 1, wherein the portable electronic device includes a plurality of electrical components, and wherein one or more of the electrical components are inactivated if operating the portable electronic device in the e-reader mode.

4. A method as recited in claim 3,
wherein said method further comprises:
configuring the portable electronic device to operate in accordance with a default system profile if said determining determines that the portable electronic device is not in the e-reader mode,
wherein the portable electronic device stores a plurality of distinct system profiles, the distinct system profiles including at least the e-reader system profile and the default system profile, and
wherein said method further comprises:
accessing the e-reader system profile if said determining determines that the portable electronic device is in the e-reader mode; and
accessing the default system profile if said determining determines that the portable electronic device is not in the e-reader mode.

5. A method as recited in claim 1,
wherein said method further comprises:
presenting an e-book on a display device associated with the portable electronic device, and
wherein said configuring of the portable electronic device to operate in accordance with the e-reader system profile comprises controlling the display device in a manner dependent on the e-reader system profile.

6. A method as recited in claim 1, wherein said configuring of the portable electronic device to operate in accordance with the e-reader system profile comprises disabling at least one integrated circuit chip, and to enable at least one specialized e-reader integrated circuit chip.

7. A method as recited in claim 1, wherein the portable electronic device includes a graphical processing unit and a low-power display controller, and wherein said configuring of the portable electronic device to operate in accordance with the e-reader system profile comprises disabling the graphical processing unit and enabling the low-power display controller.

8. A portable electronic device, comprising:
a processing unit configured to perform computer program code;
a display;
a display controller configured to control the display; and
a configuration manager operatively connected to the processing unit and/or the display controller, said configuration manager being configured to: (i) monitor whether the portable electronic device is in an e-reader mode, (ii) determine an appropriate profile for the e-reader mode, and (iii) operate the portable electronic device in accordance with the determined profile while the portable electronic device is in the e-reader mode.

9. A portable electronic device as recited in claim 8, wherein said portable electronic device comprises:
a touch sensitive input device, said touch sensitive input device being operated in a first mode if the portable electronic device is not in the e-reader mode, and said touch sensitive input device being operated in a second mode if the portable electronic device is in the e-reader mode.

10. A portable electronic device as recited in claim 8, wherein comprises:
a touch sensitive input device, said touch sensitive input device being operated in a first mode if the portable electronic device is not in the e-reader mode, and said touch sensitive input device being operated in a second mode if the portable electronic device is in the e-reader mode.

11. A portable electronic device as recited in claim 8, wherein said display controller is disabled or operates in a reduced power mode if said touch sensitive input device is operated in the e-reader mode.

12. A portable electronic device as recited in claim 8, wherein the profile comprises one or more of a system profile, a user profile, a content profile, or a presentation profile.

13. A portable electronic device as recited in claim 12, wherein said configuration manager is further configured determine the profile from two or more of the one or more of a system profile, a user profile, a content profile, or a presentation profile.

14. A method for operating a portable electronic device to present an e-book on a display device associated with the portable electronic device, said method comprising:
determining whether an e-book is to be presented on the display device;
accessing an e-book presentation profile corresponding to the e-book if it is determined that the e-book is to be presented on the display device;
configuring the portable electronic device in accordance with the e-book presentation profile; and
presenting the e-book on the display device of the configured portable electronic device.

15. A computer readable medium including at least computer program code stored thereon for configuring a portable electronic device to present an e-book on a display device associated with the portable electronic device, said computer readable medium comprising:
computer program code for accessing an e-book presentation profile corresponding to the e-book;
computer program code for configuring the portable electronic device in accordance with the e-book presentation profile; and
computer program code for presenting the e-book on the display device of the configured portable electronic device.

16. A computer readable medium including at least computer program code stored thereon for operating a portable electronic device to present an e-book on a display device associated with the portable electronic device, said computer readable medium comprising:
computer program code for determining whether an e-book is to be presented on the display device;
computer program code for identifying a page of the e-book to be presented;
computer program code for accessing an e-book presentation profile corresponding to the e-book;
computer program code for determining a configuration of the portable electronic device for the identified page based on the e-book presentation profile;
computer program code for configuring the portable electronic device in accordance with the determined configuration; and
computer program code for presenting the e-book on the display device of the configured portable electronic device.

17. A computer readable medium as recited in claim 16, wherein said computer program code for presenting comprises:
computer program code for accessing page content for the identified page; and
computer program code for presenting the page content for the identified page.

18. A computer readable medium as recited in claim 17, wherein said method comprises:
computer program code for determining whether a next page of the e-book is to be presented;
computer program code for determining a next configuration of the portable electronic device for the next page based on the e-book presentation profile;
computer program code for configuring the portable electronic device in accordance with the determined next configuration; and
computer program code for presenting the next page of the e-book on the display device of the configured portable electronic device.

19. A method for operating a portable electronic device to present an e-book on a display device associated with the portable electronic device, said method comprising:
determining whether the portable electronic device is in an e-reader mode;
identifying an e-book to be presented;
providing a plurality of virtual frame buffers for storage of e-book content for the e-book in a data storage device of the portable electronic device;
configuring the portable electronic device to operate in the e-reader mode if said determining determines that the portable electronic device is in the e-reader mode; and
presenting at least a portion of the e-book on the display device of the configured portable electronic device using the e-book content stored in the virtual frame buffers.

20. A method as recited in claim 19,
wherein said providing of the plurality of virtual frame buffers for the e-book in memory within the portable electronic device comprises:
generating page data to be stored in the virtual frame buffers at the portable electronic device; and
storing the page data to the memory hosting the virtual frame buffers.

21. A method as recited in claim 19, wherein said method further comprises:
configuring the portable electronic device to operate in accordance with a e-reader profile if said determining determines that the portable electronic device is in the e-reader mode.
